(19) United States
(12) Patent Application Publication
(10) Pub. No.: US 2024/0324054 A1
(43) Pub. Date: Sep. 26, 2024

(54) METHOD PERFORMED BY USER EQUIPMENT AND USER EQUIPMENT

(71) Applicant: SHARP KABUSHIKI KAISHA, Osaka (JP)

(72) Inventors: CHONGMING ZHANG, Shanghai (CN); RENMAO LIU, Shanghai (CN)

(21) Appl. No.: 18/575,424

(22) PCT Filed: Jul. 20, 2022
(86) PCT No.: PCT/CN2022/106774

§ 371 Date: Dec. 29, 2023

(30) Foreign Application Priority Data
Jul. 22, 2021 (CN) 202110833830.2

(51) Int. Cl. H04W 76/27; H04W 60/06; H04W 74/0833; H04W 76/19

(52) U.S. Cl. CPC H04W 76/27; H04W 60/06; H04W 74/0833; H04W 76/19

(57) ABSTRACT

Provided in the present invention is a method performed by user equipment, being a method performed by the user equipment (UE) configured with dual connectivity or multi-connectivity during communication with a master cell group (MCG) and a secondary cell group (SCG), comprising the following steps: the UE receiving indication information to deactivate the SCG; when the UE receives the indication information to deactivate the SCG, performing at least one of the following operations: indicating the SCG deactivation indication information to an upper layer, wherein the upper layer is an RRC layer or an RLC layer; in the RLC layer or the RRC layer, on the basis of the indication information or after receiving the indication information, the UE re-establishing an RLC entity, wherein the RLC entity is an RLC entity that is located on the SCG, i.e., an SCG RLC entity; and in the RRC layer, on the basis of the indication information or after receiving the indication information, the UE instructing the RLC layer to re-establish the SCG RLC entity.

### TECHNICAL FIELD

The present invention relates to the technical field of wireless communications. More specifically, the present invention relates to a method performed by user equipment, and corresponding user equipment.

### BACKGROUND

With the rapid growth of mobile communications and great progress of technology, the world will move toward a fully interconnected network society where anyone or anything can acquire information and share data anytime and anywhere. To meet the requirements on enhanced mobile broadband services and the communication requirements on massive Internet of Things terminals, research on new-generation communication technology (5G) is carried out to facilitate technical enhancements for users in dual-connectivity and multi-connectivity (RP-181469: New WID on DC and CA enhancements).

Dual connectivity or multi-connectivity means that UE operating in a connected state establishes a physically established wireless connection with more than one network node and implements data transmission. A master node (MN) and a secondary node (SN) are included. The MN is executed by one Gnb/Enb/ng-eNB. A serving cell group controlled by the MN is referred to as a master cell group (MCG). Correspondingly, the SN is executed by one or more Gnbs/Enbs/ng-eNBs. A serving cell group controlled by the SN is referred to as a secondary cell group (SCG).

UE configured with dual connectivity or multi-connectivity may achieve a high data rate by communicating with the MCG and the SCG. Correspondingly, however, in order to maintain communication with two network nodes, power consumption of the UE is also doubled. To reduce power consumption of the UE, the SCG may be deactivated in a suitable case, such as when communication traffic of the UE is small. The deactivation command may be carried in the MAC CE, or in the DCI, thereby enabling a fast deactivation operation. Conversely, an activation command may also be carried in the MAC CE or the DCI, thereby activating the deactivated SCG. Upon receiving the deactivation command described above, the UE may perform data transmission via the SCG, including an initial transmission and a retransmission of the data. Since the deactivated SCG will no longer perform transmission and reception of data, data transmission being performed by the UE is interrupted, and data packets that have not been transmitted, or have not been successfully transmitted, are stored in the RLC layer. In one case, these data packets that have not been transmitted may cause the UE to make a determination error, thereby triggering an SCG activation request. In another case, these data packets that have not been transmitted may be transmitted to a base station when the next SCG is activated, thereby causing confusion on reception. Therefore, how to process this cached data is a problem that needs to be solved.

### SUMMARY

The present invention proposes a solution to the following problems, that is, a solution is provided for how to process this cached data that has not yet been transmitted or has not been successfully transmitted.

An objective of the present invention is to provide a method performed by user equipment, and corresponding user equipment capable of correctly processing this cached data that has not yet been transmitted or has not been successfully transmitted.

According to an aspect of the present invention, provided is a method performed by user equipment, being a method performed by user equipment (UE) configured with dual connectivity or multi-connectivity during communication with a master cell group (MCG) and a secondary cell group (SCG), the method comprising the following steps:
the UE receiving indication information to deactivate the SCG;
when the UE receives the indication information to deactivate the SCG, performing at least one of the following operations:
indicating the SCG deactivation indication information to an upper layer, wherein the upper layer is an RRC layer or an RLC layer;
in the RLC layer or the RRC layer, on the basis of the indication information or after receiving the indication information, the UE re-establishing an RLC entity, wherein the RLC entity is an RLC entity located on the SCG, i.e., an SCG RLC entity;
and in the RRC layer, on the basis of the indication information, or after receiving the indication information, the UE instructing the RLC layer to re-establish the SCG RLC entity.

In the foregoing method performed by user equipment, preferably, the following steps are further comprised:
the UE receiving indication information to activate the SCG;
when the UE receives the indication information to activate the SCG, performing at least one of the following operations:
indicating the SCG indication information to an upper layer, wherein the upper layer is the RRC layer or the RLC layer;
in the RLC layer or the RRC layer, on the basis of the indication information or after receiving the indication information, the UE re-establishing the RLC entity, wherein the RLC entity is an RLC entity located on the SCG, i.e., an SCG RLC entity;
and in the RRC layer, on the basis of the indication information, or after receiving the indication information, the UE instructing the RLC layer to re-establish the SCG RLC entity.

In the above-described method performed by user equipment, preferably,
the above re-establishment comprises at least one of the following operations:
if a corresponding RLC SDU, RLC SDU segment, or RLC PDU exists, discarding all RLC SDUs, RLC SDU segments, and RLC PDUs;
stopping and resetting all timers; and
resetting all state variables to an initial value thereof.

In the foregoing method performed by user equipment, preferably, the following steps are further comprised:
after the UE receives the indication information to deactivate the SCG and performs a related operation of deactivating the SCG, performing the following operations:
the UE deciding to activate the deactivated SCG for data transmission and re-establishing the RLC entity; or,
the UE deciding to activate the deactivated SCG and performing a random access procedure on the SCG, and re-establishing the RLC entity when the random access is successfully completed.

In the above-described method performed by user equipment, preferably,
for the above indication information to deactivate the SCG,
an RRC message is provided, and the message carries an indication therein used to instruct the UE to deactivate a currently configured SCG; or
an SCG deactivation MAC CE is provided, and the MAC CE carries an indication therein used to instruct the UE to deactivate the currently configured SCG.

In the above-described method performed by user equipment, preferably,
for the above indication information to deactivate the SCG,
a serving cell deactivation MAC CE is provided, and when deactivation of the primary second cell (PSCell) of the SCG is indicated in the MAC CE, the UE considers that the indication information to deactivate the SCG has been received; or
a DCI format is set, the DCI format carrying a field, the field or a value of the field indicating deactivation of the PSCell of the SCG, and when the UE receives a PDCCH carrying the DCI format, it is considered that the indication information to deactivate the SCG has been received.

In the above-described method performed by user equipment, preferably,
for the above indication information to activate the SCG,
an RRC message is provided, and the message carries an indication therein used to instruct the UE to activate the currently configured SCG; or
an SCG activation MAC CE is provided, and the MAC CE carries an indication therein used to instruct the UE to activate the currently configured SCG.

In the above-described method performed by user equipment, preferably,
for the above indication information to activate the SCG,
a serving cell activation MAC CE is provided, and when activation of the primary second cell (PSCell) of the SCG is indicated in the MAC CE, the UE considers that the indication information to activate the SCG has been received; or,
a DCI format is set, the DCI format carrying a field, the field or a value of the field indicating activation of the PSCell of the SCG, and when the UE receives a PDCCH carrying the DCI format, it is considered that the indication information to activate the SCG has been received.

In the above-described method performed by user equipment, preferably,
the above SCG RLC entity is a split bearer or an SCG bearer, wherein the split bearer is a radio bearer having an RLC bearer on both the MCG and on the SCG in dual connectivity, the SCG bearer being a radio bearer having one or two RLC bearers on only the SCG in dual connectivity.

According to another aspect of the present invention, user equipment is provided, comprising:
a processor; and
a memory storing instructions, wherein
the instructions, when run by the processor, cause the user equipment to perform the method described above.

According to the method performed by user equipment and the corresponding user equipment involved in the present disclosure, this cached data that has not yet been transmitted or has not been successfully transmitted can be correctly processed.

### BRIEF DESCRIPTION OF THE DRAWINGS

FIG. 1 is a flowchart showing a method performed by user equipment according to an embodiment of the present invention.

FIG. 2 is a simplified structural block diagram of user equipment according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

Prior to the specific description, several terms mentioned in the present invention are illustrated as follows. The terms involved in the present invention shall have the meanings set forth below, unless otherwise indicated.
UE: User Equipment
NR: New Radio
eLTE: enhanced Long Term Evolution
E-UTRAN: Evolved Universal Terrestrial Radio Access Network
DC: Dual Connectivity
MC: Multi-Connectivity
Gnb: a base station node which provides UE with NR user plane and control plane protocol stacks and is connected to a 5G core network
Enb: a base station node which provides UE with E-UTRAN user plane and control plane protocol stacks and is connected to an EPC core network
Ng-enb: a base station node which provides UE with E-UTRAN user plane and control plane protocol stacks and is connected to a 5G core network
SRB: Signaling Radio Bearer
DRB: Data Radio Bearer
Split SRB: Split Signaling Radio Bearer
RLC: Radio Link Control layer
PDCP: Packet Data Convergence Protocol layer
MAC: Media Access Control layer
RRC: Radio Resource Control layer
SRS: Sounding Reference Signal
CSI: Channel State Information
PDCCH: Physical Downlink Control Channel
PUCCH: Physical Uplink Control Channel
DCI: Downlink Control Information
SDU: Service Data Unit
PDU: Protocol Data Unit

Dual connectivity or multi-connectivity means that UE operating in a connected state establishes a physically established wireless connection with more than one network node, and implements data transmission. A master node (MN) and a secondary node (SN) are included.

The MN is executed by one base station, which may be a Gnb that supports 5G technology (New RAT, NR) or an Enb that supports 4G technology, and may also be an ng-eNB that supports connection to a next generation core network (5G core network).

A serving cell group controlled by the MN is referred to as a master cell group (MCG). At least one primary serving cell is present, and is referred to as a primary cell (PCell). UE performs radio link monitoring (RLM) on the PCell. If the MCG further includes other cells, then the other cells may be referred to collectively as a secondary serving cell (SCell). An SRB established between the MN and the UE is commonly referred to as SRB1, and is mainly used to transmit an RRC message between the MN and the UE.

The SN is executed by one base station, which may be a Gnb that supports 5G technology or an Enb that supports 4G technology, and may also be an ng-eNB that supports connection to a next generation core network (5G core network). A serving cell group controlled by the SN is referred to as a secondary cell group (SCG). The SCG at least includes a primary serving cell referred to as a PSCell (Primary Second Cell).

The UE performs radio link monitoring on the PSCell. If the SCG further includes other cells, then the other cells may be referred to collectively as a secondary serving cell (SCell). An SRB may be established between the SN and the UE, and is commonly referred to as SRB3, and is mainly used to transmit an RRC message between the SN and the UE, e.g., an SCG-associated measurement report.

Specific embodiments of the present invention are described in detail below. In addition, as described above, the embodiments of the present invention are exemplary descriptions for facilitating understanding of the present invention, and are not intended to limit the present invention.

### Example 1

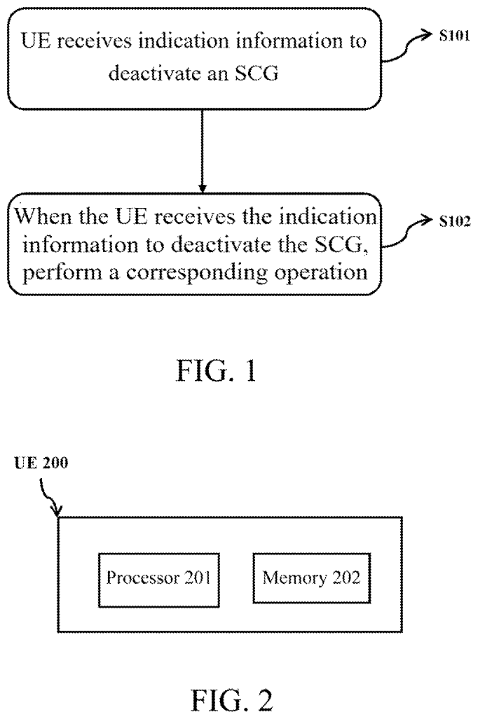

Provided in the present example is a method performed by UE configured with dual connectivity or multi-connectivity during communication with an MCG and the SCG. As shown in FIG. 1, the method includes:
step S101: the UE receiving indication information to deactivate the SCG, and preferably this deactivation indication information is carried in the MAC CE, or in physical layer signaling (e.g., DCI).
Step S102: when the UE receives the indication information to deactivate the SCG, the UE performing at least one or more of the following operations:
   indicating the SCG deactivation information to an upper layer, here the upper layer may be an RRC layer or an RLC layer.
   In the RLC or RRC layer, on the basis of the indication information or after receiving the indication information, the UE re-establishing the RLC entity. The RLC entity here refers to an RLC entity located on the SCG, also referred to as an SCG RLC entity
   The re-establishment operation includes at least one or a plurality of the following operations:
      operation I: discarding all RLC SDUs, RLC SDU segments, and RLC PDUs (a corresponding operation is performed only if a corresponding RLC SDU, RLC SDU segment, or RLC PDU exists).
      Operation II: stopping and resetting all timers, such as retransmission timers, or timers that control waiting for a receive window.
      Operation III: resetting all state variables to an initial value thereof, for example, setting an initial value of zero.
   In the RRC layer, on the basis of the indication information or after receiving the indication information, the UE may further instruct the RLC layer to re-establish the SCG RLC entity.

### Example 2

The UE receives indication information to activate the SCG, and preferably this activation indication information is carried in the MAC CE, or in physical layer signaling (e.g., DCI).

When the UE receives the indication information to activate the SCG, the UE performs at least one or more of the following operations:
indicating the SCG activation information to the upper layer, here the upper layer may be the RRC layer or the RLC layer.
In the RLC or RRC layer, on the basis of the indication information or after receiving the indication information, the UE re-establishing the RLC entity. The RLC entity here refers to an RLC entity located on the SCG, also referred to as an SCG RLC entity.
The re-establishment operation includes at least one or a plurality of the following operations:
   operation I: discarding all RLC SDUs, RLC SDU segments, and RLC PDUs (a corresponding operation is performed only if a corresponding RLC SDU, RLC SDU segment, or RLC PDU exists).
   Operation II: stopping and resetting all timers.
   Operation III: resetting all state variables to the initial value thereof.
In the RRC layer, on the basis of the indication information or after receiving the indication information, the UE may further instruct the RLC layer to re-establish the SCG RLC entity.

### Example 3

The UE receives indication information to deactivate the SCG, and performs a related operation of deactivating the SCG.

Next, when the UE decides to activate the deactivated SCG to perform data transmission, the RLC entity may be re-established, and preferably, if the UE is configured with SRB3, then the UE re-establishes an RLC entity of SRB3, or the UE may further perform a re-establishment operation for all SCG RLC entities. The specific operation of the re-establishment may be based on the description in Embodiment 1.

Another embodiment of the above example may be as follows:
the UE decides to activate the deactivated SCG;
the UE performs a random access procedure on the SCG;
and the UE re-establishes the RLC entity when the random access is successfully completed.

### Example 4

The SCG deactivation indication information received by the UE in Examples 1-3 may be implemented in the following modes:
mode 1: explicit deactivation

An RRC message, preferably an RRC reconfiguration message, may be designed to include an indication therein indicating to the UE to deactivate a currently configured SCG. In particular, if the UE is configured with multiple SCGs, then the message further needs to carry a sequence number of the SCG.

On the basis of the indication, the UE performs, with respect to the deactivated SCG, any operation in the above Examples 1-3.
Mode 2: explicit deactivation

An SCG deactivation MAC CE may be designed to include an indication therein indicating to the UE to deactivate the currently configured SCG. In particular, if multiple SCGs are configured, then the MAC CE further needs to carry sequence number of the SCGs.

When the UE receives the SCG deactivation MAC CE, information indicating that the SCG is deactivated needs to be indicated to the upper layer. The upper layer herein mainly refers to the RRC layer.

The RRC layer performs, on the basis of the indication, any above operation in Examples 1-3 with respect to the deactivated SCG.
Mode 3: implicit deactivation

A serving cell deactivation MAC CE may be designed. When deactivation of the PSCell of the SCG is indicated in the MAC CE, the UE may consider that the SCG deactivation indication information has been received. The deactivation of the SCG is implicitly indicated herein by deactivation of the PSCell of the SCG.

When the UE receives the serving cell deactivation MAC CE, and when deactivation of the PSCell of the SCG is indicated in the MAC CE, information indicating that the SCG is deactivated or information indicating that the PSCell of the SCG is deactivated needs to be indicated to the upper layer. The upper layer herein mainly refers to the RRC layer.

The RRC layer performs, on the basis of the indication, any above operation in Examples 1-3 with respect to the deactivated SCG.
Mode 4: implicit deactivation

A DCI format may be designed, the DCI format carrying a field, the field or a value of the field indicating deactivation of the SCG or deactivation of the PSCell of the SCG.

When the UE receives a PDCCH carrying the DCI format, it may be considered that the indication information to deactivate the SCG has been received. Reception of the PDCCH is processed on the physical layer, so that when the PDCCH is received, information indicating that the SCG is deactivated or information indicating that the PSCell of the SCG is deactivated needs to be indicated to the upper layer.

The upper layer performs, on the basis of the indication, any above operation in Examples 1-3 with respect to the deactivated SCG.

When the UE receives the message/MAC CE/DCI in any one of the above modes, it may be considered that the UE has received a SCG deactivation command, or it may be considered that the SCG is in a deactivated/inactive state.

If the UE does not receive the message/MAC CE/DCI in any one of the above modes, it may be considered that the UE has not received any SCG deactivation command, and it may be considered that the SCG is in an activated state.

### Example 5

Embodiments of SCG activation indication information received by the UE in Examples 1-3 may be the same as in Example 4, differing in respect of the carrying of SCG activation indication information. Specifically,
mode 1: explicit activation

An RRC message, preferably an RRC reconfiguration message, may be designed to include an indication therein indicating to the UE to activate a currently configured SCG. In particular, if the UE is configured with multiple SCGs, then the message further needs to carry a sequence number of the SCG.

On the basis of the indication, the UE performs, with respect to the activated SCG, any operation in the above Examples 1-3.
Mode 2: explicit activation

An SCG activation MAC CE may be designed to include an indication therein indicating to the UE to activate the currently configured SCG that is in the deactivated/inactive state. In particular, if multiple SCGs are configured, then the MAC CE further needs to carry a sequence number of the SCG.

When the UE receives the SCG activation MAC CE, information indicating that the SCG is activated needs to be indicated to an upper layer. The upper layer herein mainly refers to the RRC layer.

The RRC layer performs, on the basis of the indication, any above operation in Examples 1-3 with respect to the activated SCG.
Mode 3: implicit activation

A serving cell activation MAC CE may be designed. When activation of the PSCell of the SCG is indicated in the MAC CE, the UE may consider that the indication information to activate the SCG has been received. The activation of the SCG is implicitly indicated herein by activation of the PSCell of the SCG.

When the UE receives the serving cell activation MAC CE, and when activation of the PSCell of the SCG is indicated in the MAC CE, information indicating that the SCG is activated or information indicating that the PSCell of the SCG is activated needs to be indicated to an upper layer. The upper layer herein mainly refers to the RRC layer.

The RRC layer performs, on the basis of the indication, any above operation in Examples 1-3 with respect to the activated SCG.
Mode 4: implicit activation

A DCI format may be designed, the DCI format carrying a field, the field or a value of the field indicating activation of the SCG or activation of the PSCell of the SCG.

When the UE receives a PDCCH carrying the DCI format, it may be considered that an SCG activation command has been received. The reception of the PDCCH is processed on a physical layer, so that when the PDCCH is received, information indicating that the SCG is activated or information indicating that the PSCell of the SCG is activated needs to be indicated to an upper layer.

The upper layer performs, on the basis of the indication, any above operation in Examples 1-3 with respect to the activated SCG.

When the UE receives the message/MAC CE/DCI in any one of the above modes, it may be considered that the UE has received the SCG activation command, or it may be considered that the SCG is in an activated state.

If the UE does not receive the message/MAC CE/DCI in any one of the above modes, it may be considered that the UE has not received any SCG activation command, and it may be considered that the SCG is in the deactivated/inactive state.

### Example 6

In Examples 1-5, the SCG RLC entity may be a split bearer or an SCG bearer. Such a bearer may belong to a signaling radio bearer (SRB) or a data radio bearer (DRB).

Here, a split bearer refers to a radio bearer (in MR-DC, a radio bearer with RLC bearers both in MCG and SCG) having an RLC bearer on both the MCG and on the SCG in dual connectivity or multi-connectivity.

An SCG bearer refers to a radio bearer having one or two RLC bearers on only the SCG in dual connectivity, wherein two RLC bearers refer to the case in which carrier aggregation data packets are duplicated (in MR-DC, a radio bearer with an RLC bearer (or two RLC bearers, in case of CA packet duplication) only in the SCG).

In Examples 1-5, the RLC entity is managed or configured by SN, and thus may also be referred to as an SCG RLC bearer, which refers to RLC and a logical channel configuration on the SCG.

FIG. 2 is a simplified structural block diagram of user equipment according to the present invention. As shown in FIG. 2, user equipment (UE) 200 includes a processor 201 and a memory 202. The processor 201 may include, for example, a microprocessor, a microcontroller, an embedded processor, and the like. The memory 202 may include, for example, a volatile memory (such as a random access memory (RAM)), a hard disk drive (HDD), a non-volatile memory (such as a flash memory), or other memories. The memory 202 stores program instructions. The instructions, when run by the processor 201, may perform the method performed by user equipment as described above in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulted from the appropriate combinations of the technical means disclosed in different embodiments are also included within the technical scope of the present invention. In addition, components with the same effect described in the above embodiments may be replaced with one another.

1. A method performed by a user equipment, the method comprising the following steps:
upon receiving a Radio Resource Control (RRC) reconfiguration message which includes an indication to perform Secondary Cell Group (SCG) deactivation,
re-establishing a Radio Link Control (RLC) entity of a SCG bearer.

2-9. (canceled)

10. A user equipment, comprising:
a processor; and
a memory in electronic communication with the processor, wherein instructions stored in the memory are executable to:
upon receiving a Radio Resource Control (RRC) reconfiguration message which includes an indication to perform Secondary Cell Group (SCG) deactivation,
re-establish a Radio Link Control (RLC) entity of a SCG bearer.

11. The user equipment according to claim 10, wherein
upon activating the deactivated SCG, initiate a random access procedure on the SCG.

12. A base station, comprising:
a processor; and
a memory in electronic communication with the processor, wherein storing instructions stored in the memory are executable to:
transmit, to a user equipment, a Radio Resource Control (RRC) reconfiguration message which includes an indication to perform Secondary Cell Group (SCG) deactivation, wherein
upon receiving the RRC reconfiguration message, the user equipment re-establish a Radio Link Control (RLC) entity of a SCG bearer.
